(19) United States
(12) Patent Application Publication
(10) Pub. No.: US 2025/0331668 A1
(43) Pub. Date: Oct. 30, 2025

(54) ACCESS POINT DEVICE, SYSTEM AND METHOD FOR AUTONOMOUS VEHICLE DELIVERY

(71) Applicant: DRONE DOOR LTD., BETHLEHEM, PA (US)

(72) Inventor: Araine Brown, BETHLEHEM, PA (US)

(21) Appl. No.: 19/069,305

(22) Filed: Mar. 4, 2025

Related U.S. Application Data
(60) Provisional application No. 63/638,405, filed on Apr. 24, 2024.

(51) Int. Cl. A47G 29/122; G05B 19/4155

(52) U.S. Cl. CPC A47G 29/122; G05B 19/4155; G05B 2219/34443

(57) ABSTRACT

A system configured to support autonomous receipt of packages carried via a courier comprising a housing; a movable panel disposed in the housing and configured to automatically open and close an aperture in the housing; an actuator disposed in a portion of the housing for automatically opening or closing the movable panel; a sensor disposed in a portion of the housing or the movable panel for detecting whether a carrier of a package is within a predetermined region associated with the moveable panel; a computer controller disposed in a portion of the housing and communicatively coupled with the sensor and the actuator, wherein the controller generates a signal to cause the actuator to open the panel in response to detection by the sensor to enable receipt of the package into the housing by the carrier; wherein a communication hub disposed in a portion of the housing or on the panel enables communications from the computer controller as to a status of one or more of the package and the movable panel.

### CROSS REFERENCE TO RELATED APPLICATIONS

The present disclosure claims priority benefit under 35 U.S.C. 119(e) to U.S. provisional patent application Ser. No. 63/638,405 filed on Apr. 24, 2024, the subject matter thereof incorporated by reference herein in its entirety.

### FIELD OF INVENTION

The present disclosure relates to autonomous delivery access points.

### BACKGROUND

Autonomous drone delivery is set to revolutionize the delivery industry that has been around since before the first mail carrier. With the rise of technology, the types of parcels and how they are delivered have changed. How the intended recipient receives a package must likewise change. FIGS. 1A and 1B depict two traditional access points 5, 15, illustrating unattended packages, parcels, or mail which depict problems in the chain of custody and autonomy in the delivery system. The delivery industry is a complex and dynamic system that involves multiple stakeholders and processes. Use of advanced technologies such as autonomous delivery systems, big data analytics, and artificial intelligence is transforming the industry, making it more efficient, reliable, and customer-centric. However, the final stage of the delivery process presents significant problems for both the delivery device as well as the recipient. A need exists for safer, more effective, and more autonomous methods, devices, and systems for receipt of packages at a target location.

### SUMMARY

Embodiments of the present disclosure address the foregoing disadvantages of the prior art, as well as provide additional advantages. For example, the present disclosure eliminates many challenges associated with autonomous delivery systems, which include the need for a human to meet a delivery robot to pick up a package. However, with an automatic door or window-like device, the delivery drones can autonomously deliver packages inside the customer's home or business, eliminating the need for human intervention and increasing the autonomy and efficiency of the delivery process. Further, customers no longer need to be present to receive their deliveries. This means that they can receive their packages at any time, even when they are not at home or in the office. This increases convenience for the customer and reduces the need for rescheduling or redelivery attempts. The present disclosure provides for an automatic door or window-like device configured to only allow authorized delivery drones to access the customer's property, preventing unauthorized access by humans or other drones. This enhances security and reduces the risk of theft or damage to packages. Further still, enabling delivery drones to deliver packages directly to a customer's location reduces traffic congestion, air pollution, and carbon emissions, leading to a more sustainable and environmentally friendly delivery system.

Further advantages include reduction in costs associated with manual package delivery, including labor, transportation, and fuel costs. With less need for human intervention in the delivery process, companies can save costs relating to certain personnel, as well as save on lost recovery, prevention, and refunds. The present solution is not limited to aerial drones, but can also be used for ground delivery robots. This provides flexibility for companies to use different types of autonomous delivery drones for different types of deliveries and environments.

In an embodiment, the present disclosure provides for a device, method and system that can be embedded into standard size openings, such as standard windows or doors, for enabling secure access by aerial and/or ground carriers or autonomous vehicles.

In another embodiment, the present disclosure provides for a device, method and system that can be removably inserted into standard window frames (or other openings) in a plug-and-play design, rather than being embedded into the frame and/or housing structure itself. Such plug-and-play design comprises a housing with built-in drawer, capable of autonomously extending in two directions. In an embodiment, the drawer in the container will extend away from the housing that the device is installed in, to receive deliveries. The closed position of the drawer will close off both orifices. The drawer can then extend/retract into the housing, allowing a user inside to receive the package.

In an embodiment, there is disclosed a system comprising a housing and a movable panel disposed in the housing and configured to automatically open and close an aperture in the housing. One or more actuators are disposed in a portion of the housing or on the movable panel for automatically opening or closing the movable panel. Preferably, the one or more actuators are positioned at the extremity of the housing frame or movable panel to enable gravity to assist with the opening of the device. One or more sensors are disposed in a portion of the housing or the movable panel for detecting whether a carrier of a package (e.g. an aerial drone) is within a predetermined region or area associated with the moveable panel. A computer controller including a computer processing unit (CPU) and memory (RAM, ROM, cache, etc.) is disposed in a portion of the housing or the movable panel. The controller is communicatively coupled to both the one or more sensors as well as the one or more actuators in order to receive and transfer communications signals and commands to these components. The controller generates a control signal to cause the actuator to open the panel in response to detection by the sensor of the carrier, and also based on authentication of the carrier as authorized for entry to the access point device, so as to enable receipt of the package into the housing by the carrier. A communication hub is disposed in a portion of the housing or on the panel and enables communications between the computer controller as to status of at least one of the package and the movable panel. Authorization of a given carrier may be established via communication of a unique ID of the carrier desiring access to the particular access point, and comparison with a data base or lookup table containing authorized carrier IDs and related information (e.g. time schedules) associated with the particular access point, in order to proceed with the opening of the movable panel for package delivery.

In an embodiment, the carrier comprises an aerial drone.

In another embodiment, the carrier comprises a land-based drone.

In an embodiment, the device comprises a controller with CPU and memory for communicating with the drone, as well as with the sensors and actuators and communications hub for communicating via an intra-net network as well as via the internet, e.g. via wireless and/or wired technologies. The CPU, and/or web server are further operative to store unique identifiers (IDs) associated with the particular access point device, as well as store IDs of carriers who are authorized to access a particular access point. Such access authorization may be provided by way of real-time communications from the drone, or via third party communications with the system to enable access by a given drone, or based on a temporal schedule or time window during which a given drone (via ID verification) is authorized to access the given access point.

In an embodiment, an access point device comprises a housing having a slidable drawer therein. The exterior of the housing is adapted to be disposed in any of various standard-sized window apertures, in a manner akin to window air conditioning units, so as to sealingly close the window and prohibit ingress or egress there through. The slidable drawer is housed within the housing container. The slidable drawer may be positioned in a first (inactive or closed) position within the housing such that a first end of the slidable drawer and the housing within the window completely blocks access to/from the exterior environment such that the access point is in a closed state. The slidable drawer is configured to be moved (e.g. horizontally) to a second (active or open) position such that a portion of the drawer including the first end extends outside of the housing to the exterior environment to receive a package carried via an authorized carrier. Upon receipt of the package into the drawer, or upon expiration of a timer, the slidable drawer is further configured to move back to the inactive or closed position, and/or further move to a third (delivered) position, such that a portion of the drawer including a second end extends outside of the housing to the interior environment to deliver the received package at a position for user pickup. At the third position, the first end of the drawer disposed within the housing serves to maintain the access point in the closed state. One or more actuators are configured for moving the slidable drawer in response to instructions from the controller and based on both sensor detection and carrier ID authorization (authentication). One or more sensors are configured for detecting whether a carrier of a package (e.g. an aerial drone) is within a predetermined region or area associated with the moveable drawer, and for subsequently detecting the presence of the package within the drawer and communicating with the controller for causing drawer activation.

In an embodiment, the one or more actuators comprises one or more stepper motors. The stepper motors are disposed within a motor housing, and the housing connects to the side of the window. In one embodiment, a belt inside the substantially hollow window frame allows the window to lean forward and wheel the window down and then back up, enabling the window itself to act as a surface on which to have the package slide onto and ultimately into the housing. This allows the window to remain functional, with the only modification being to modify a side of the wall to house the motors to be partially embedded in the wall and also connected to the window (or door) frame.

### BRIEF DESCRIPTION OF THE DRAWINGS

A more detailed understanding may be had from the following description, given by way of example in conjunction with the accompanying drawings wherein:

FIGS. 1A and 1B depict two traditional access points illustrating unattended packages, parcels, or mail which depict problems in the chain of custody and autonomy in the delivery system.

FIG. 2 illustrates an exemplary pivoting window panel access point device according to an embodiment of the present disclosure.

FIG. 3 illustrates an exemplary vertically movable door panel access point device according to an embodiment of the present disclosure.

FIG. 4 illustrates an exemplary horizontally movable drawer panel access point device according to an embodiment of the present disclosure.

FIG. 5 shows a block diagram illustrating various electronic and mechanical components of an access point device according to an embodiment of the present disclosure.

FIG. 6 shows a schematic view of multiple different access point devices within a home or building according to embodiments of the present disclosure.

FIGS. 7A, 7B, and 7C schematically illustrate three different variations of an access point solution configured on a roof to operate as a multi-functioning device, including operability as a window, according to embodiments of the present disclosure.

FIG. 8 illustrates a schematic view of a web server according to an embodiment of the disclosure.

FIG. 9 schematically illustrates an access point device in an outwardly extending window configuration for receiving and collecting a package according to an embodiment of the present disclosure.

FIG. 9A shows a more detailed illustration of the access point device of FIG. 9 in an open configuration.

FIG. 9B shows a more detailed illustration of the access point device of FIG. 9 in a closed configuration.

FIG. 9C shows a more detailed illustration of the access point device of FIG. 9 in an open configuration.

FIG. 9D shows a more detailed schematic illustration of the extension rod and panel connection of the access point device of FIG. 9.

FIG. 10 illustrates a schematic view of an auto-retrieval vehicle according to an embodiment of the present disclosure.

FIG. 11 is a schematic illustration of an access point device configuration of window panels to form a chute according to an embodiment of the disclosure.

FIG. 12 is a schematic illustration of an access point device configuration of a window panel using a drawstring method to lower the window using a pivoting point according to an embodiment of the disclosure.

FIG. 13 is a schematic illustration of an access point device configuration of a window panel similar to that of FIG. 12 showing different corner, pivot, and drawstring mechanism design according to an embodiment of the disclosure.

FIGS. 14-16 are schematic illustrations of an access point device configuration using a three-panel design configuration according to embodiments of the disclosure.

FIG. 17 is a schematic illustration of an access point device configuration of a window panel that uses motors at a pivoting point to leverage the window.

FIG. 18 is a schematic illustration of an access point configuration using draw string window design and mesh according to an embodiment of the disclosure.

FIG. 19 is a schematic illustration of an access point configuration using a mesh retraction and release mechanism according to an embodiment of the disclosure.

FIGS. 20A and 20B are schematic illustrations of an access point drawer configuration in an active or open receive position for receiving a package according to an embodiment of the disclosure.

FIG. 21 is a further schematic illustration of an access point drawer configuration illustrating various positions associated with the drawer movement through the housing according to an embodiment of the disclosure.

FIG. 22A is a schematic illustration of an access point drawer configuration illustrating the device in a closed position according to an embodiment of the disclosure.

FIG. 22B is a schematic illustration of an access point drawer configuration illustrating the device in a delivered open position according to an embodiment of the disclosure.

FIG. 23A is a schematic perspective view showing a portion of an access point drawer configuration housing according to an embodiment of the disclosure.

FIG. 23B is a schematic perspective view showing a portion of an access point drawer configuration drawer panel according to an embodiment of the disclosure.

FIG. 24A is a schematic perspective view showing a portion of an access point drawer configuration illustrating a received package according to an embodiment of the disclosure.

FIG. 24B is a schematic perspective view showing a portion of an access point drawer configuration illustrating an empty cavity for receiving a package according to an embodiment of the disclosure.

FIGS. 25A and 25B show partial sectional views of a further variation of an access point drawer configuration according to an embodiment of the disclosure.

FIGS. 26A, 26B, and 26C show additional variations of access point drawer configurations according to embodiments of the disclosure.

FIG. 27 illustrates a more detailed illustration of the access point device 300 door configuration of FIG. 3.

FIGS. 28A and 28B illustrate perspective views of a panel associated with an access point device door configuration according to an embodiment of the disclosure.

FIG. 29A illustrates a perspective view of an exterior surface of a panel for an access point device door configuration according to an embodiment of the disclosure.

FIG. 29B illustrates a perspective view of an exterior surface of a panel for an access point device door configuration according to another embodiment of the disclosure.

FIG. 30A illustrates a perspective view of a frame housing for an access point device door configuration according to another embodiment of the disclosure.

FIG. 30B illustrates a perspective view of a frame housing for an access point device door configuration illustrating a gear and motor actuator according to an embodiment of the disclosure.

FIG. 31 illustrates a detailed illustration of an access point device door configuration according to an embodiment of the disclosure.

FIG. 32 is a schematic illustration of process flow for managing an access port with PIR and package detection, updates and command reception according to an embodiment of the disclosure.

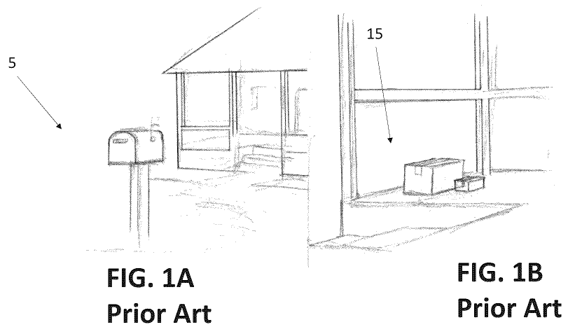

### DETAILED DESCRIPTION

Embodiments of the disclosure illustrate various aspects of devices, systems and methods for providing access points for autonomous delivery vehicles.

As illustrated in the drawings, wherein like reference numerals are used to indicate like parts, there are shown devices, methods, and systems configured to support autonomous receipt of packages carried via a mobile carrier, such as an aerial drone or a ground-based mobile vehicle. In one embodiment, the access point device may be embedded into various sized openings, such as standard (or non-standard) size openings, such as standard windows or doors, for enabling secure access by aerial and/or ground carriers or autonomous vehicles. In embodiments, the device may be removably inserted, attached, and/or otherwise secured to window frames, door frames, or other openings, in a plug-and-play design.

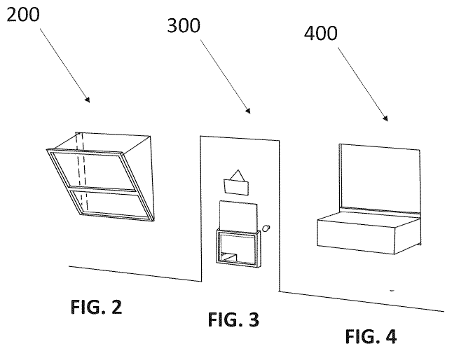

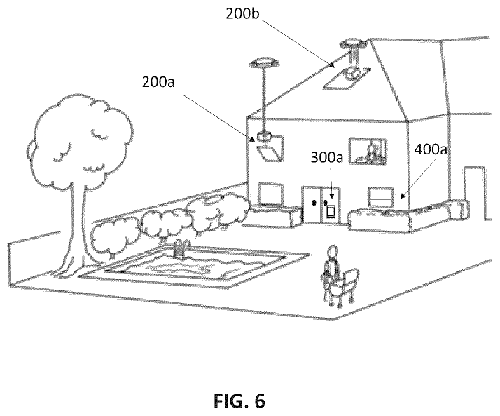

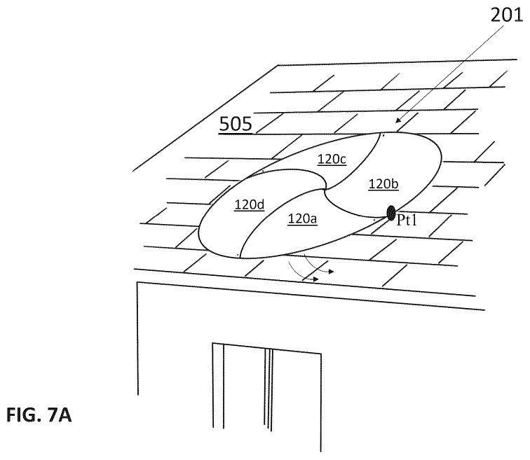

Referring now to FIGS. 2, 3, and 4, there are shown various access point devices embodied in various panel configurations illustrated as a pivoting window 200, vertically movable door 300, and horizontally movable drawer 400, respectively, according to embodiments of the present disclosure. FIG. 6 shows four distinct access point devices 200a, 200b, 300a, and 400a, positioned in four distinct locations of an enclosure for receiving packages based on specific user settings and configurations according to aspects of the present disclosure.

### Window Panel Configuration

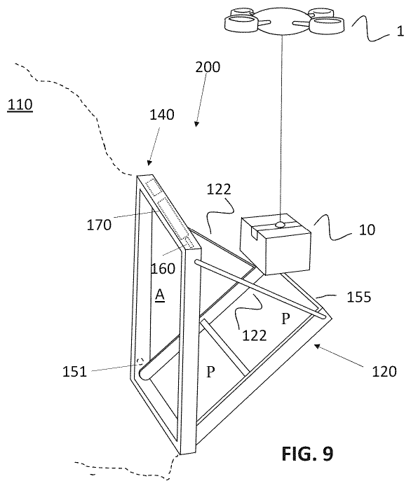

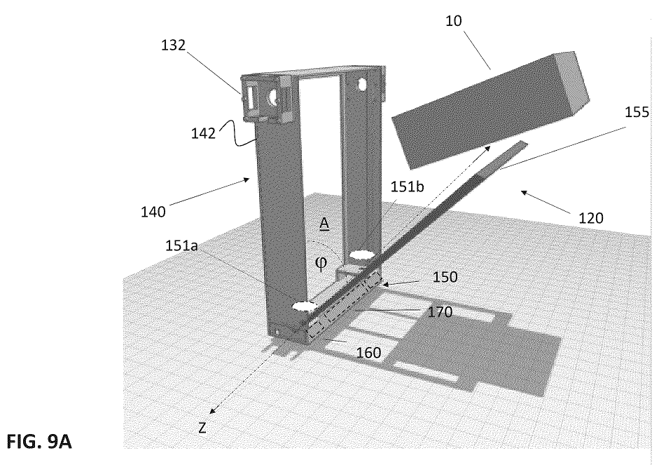

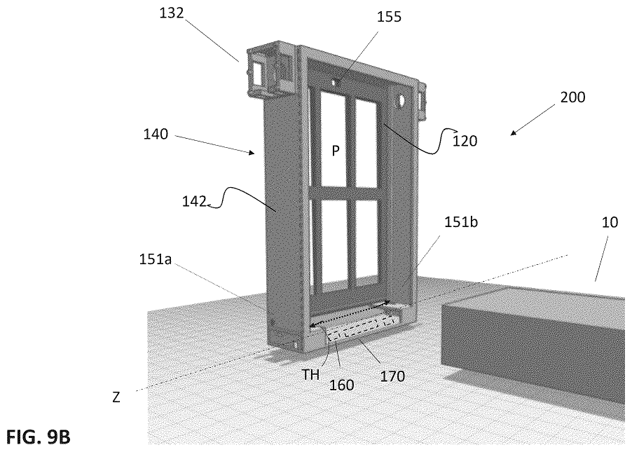

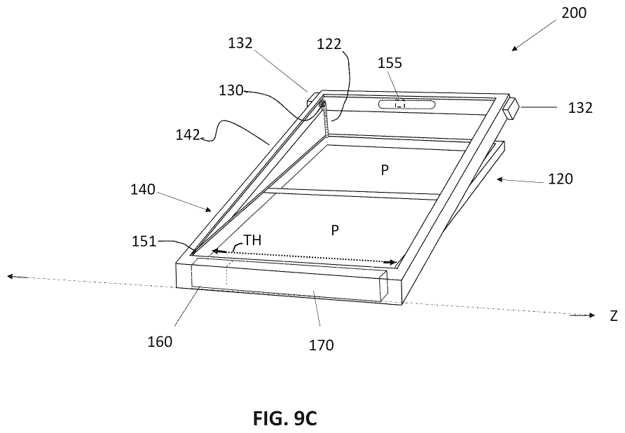

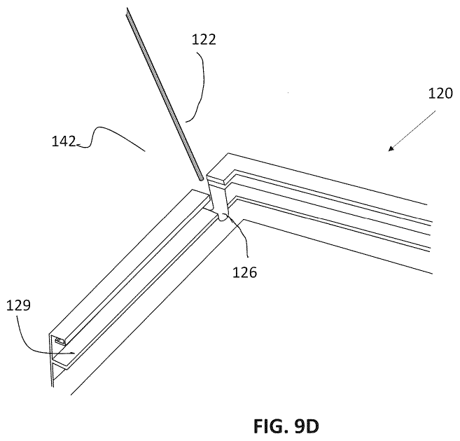

Referring now to FIG. 9 in conjunction with FIG. 5, there is shown a carrier 1 such as an aerial drone carrying a package 10 for entry into an enclosure via access point device 200 embodied as a window having a window frame 140 fixed within the overall enclosure housing 110 (e.g. residence). A movable panel 120 is pivotably attached to the window frame housing and configured to automatically open and close an aperture A in the housing according to commands from a controller 160. One or more actuators 130 (FIG. 5) are disposed in a portion of the housing or on the movable panel operate to automatically open or close the movable panel responsive to a controller command by means of extension rods 122, as shown in FIG. 9. The movable panel 120 may include one or more panes P which may be transparent (e.g. glass or other material window), translucent (e.g. material which diffuses light while obscuring details for privacy), or opaque (e.g. material which functions as a solid barrier, like a hatch, which blocks both light and visibility).

FIG. 9A illustrates an embodiment as in FIG. 9 (extension rods not shown) where the actuator motor(s) 130 are disposed in a motor housing 132 protruding outward from the outer surface of window frame 140. The protrusions or side flanges may enhance the structural integrity of the frame 140, when installed in an enclosure such as a residential or commercial building, where the window frame 140 is fitted into a wall opening that matches its dimensions. The panel 120 is pivoted about axis Z to extend at a given angle φ (e.g. from 0° (closed) to 90°) outward to the “open” position (e.g. window pivots open outward to the external environment) to receive package 10. FIG. 9B illustrates an internal view of the embodiment of FIG. 9A where the window panel 120 is pivoted to the “closed” position (i.e. closed to prevent access to the aperture and enclosure).

FIG. 9C shows a further detailed illustration of the access point device 200 of FIG. 2. Movable panel 120 is pivotally coupled to fixed frame 140 to open and close aperture A. Extension rod 122 in the form of a flexible wire connects window frame 140 with a portion of panel 120 and a hinge (not shown) such as a pivot hinge or friction hinge is operative to enable the panel's pivotal movement responsive to commands from controller 160. A bottom most portion of the window frame 140 or panel 120 may house one or more electronic components such as CPU controller 160, one or more sensors 150 (shown on top portion of frame 140 in FIG. 9) and/or comm hub 170 with Tx/Rx communications modules and electronics. In addition or in the alternative, the top most portion of the frame or panel may house one or more electronic components including the comm hub, CPU controller, and/or additional sensors and communications modules. The frame and panel peripheries may be hollow (or at least partially hollow) in order to position the electronics and any wiring for communication among components and/or external agents. FIG. 9D shows a segment of panel 120 with panel frame 129 having interior rail and cavity 126 formed in a portion of the panel frame for receiving and attachment to an end portion of extension rod 122. The opposite end of extension rod 122 is attached to an upper portion of window frame 140 as best shown in FIG. 9C.

In an alternative embodiment, a conveyor belt or actuator belt design (in contrast to the rod design of FIG. 9D) may be implemented wherein the cutout 126 may be configured for a motor arm and where the toothed actuator belt may be attached.

### Configurations and Processing Features

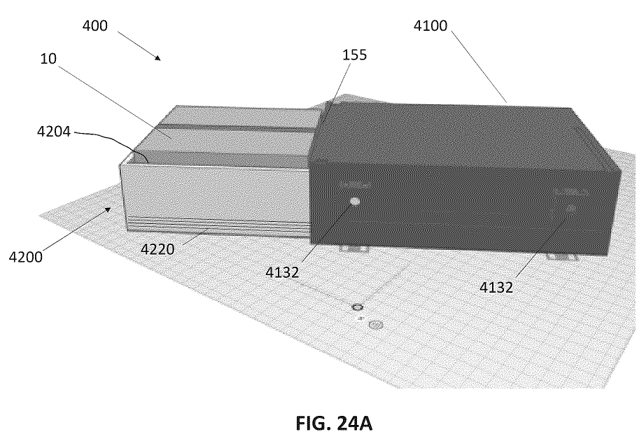

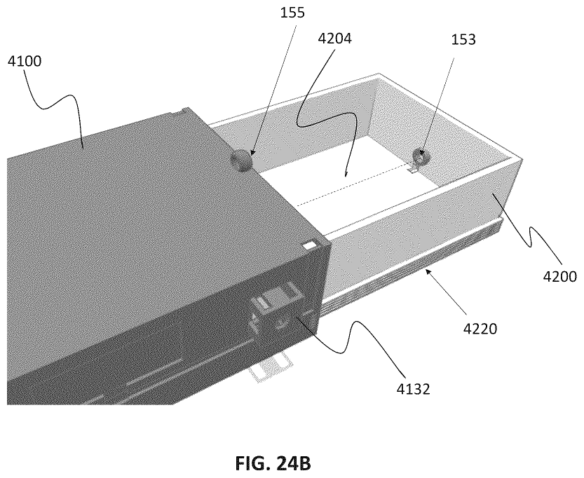

One or more sensors labeled generally as 150 (see e.g. FIG. 5) may be disposed in a portion of the housing and/or the movable panel for detecting various aspects associated with drone and/or package detection according to embodiments of the disclosure. For example, the one or more sensors 150 may be one or more PIR sensors 155 (see e.g., FIG. 9) for detecting whether a carrier of the package is within a predetermined region or area associated with (e.g. in relation to) the moveable panel. The predetermined region or area may be preset, such as being within a preselected distance of, for example, 3 feet (e.g. extending radially outward) from the aperture, and may also be required to be within the predetermined region for at least a threshold time interval, so as to avoid anomalous detections. The one or more sensors 150 may also be configured as one or more IR sensors 151 (see e.g., FIG. 9) or ultrasound sensors 155 (see e.g., FIG. 24B) positioned in relation to a threshold position associated with the aperture to monitor detection of reception of the package within the enclosure. For example, an IR sensor 151 (FIG. 9C) is disposed in frame 140 to monitor whether a package crosses the aperture threshold (TH) into the enclosure and alert the CPU controller to initiate closure of the aperture. In an embodiment, as shown in FIG. 9A, a pair of IR sensors 151a, 151b may be disposed in interior portions of the frame 140, for detecting if the threshold is crossed. As shown, while two IR sensors are utilized, it is understood that only one IR sensor may be used, or multiple IR sensors used for aperture threshold detection, depending on the size and/or configuration of the aperture. Further still, as illustrated in preferred embodiments of the present disclosure for aperture detection, one or more IR sensors may be utilized in regards to the window and door configurations, while one or more ultrasound sensors may be utilized for the drawer configuration. That is, an ultrasonic sensor may be more amenable to the drawer configuration due to the ability for sensing depth and signal coverage over a wider area and within a confined space for enabling enhanced detection upon disposal of the package within the drawer structure.

Computer controller 160 (FIG. 5) including a computer processing unit (CPU) and memory (RAM, ROM, cache, etc.) is also disposed in a portion of the housing or the movable panel. The controller is communicatively coupled to the one or more sensors as well as the one or more actuators and transceivers in order to receive and transfer communications signals and commands to the various components. Program instructions and data storage components for implementing operations and communications are stored/retrieved from memory 164. In an embodiment, the controller generates a control signal to cause the one or more actuators to open the panel in response to detection by the one or more sensors and authorization/verification to open, so as to enable receipt of the package into the enclosure from the carrier. Communication hub 170 (FIG. 5) including electronic communications components (e.g. transmitter(s), receiver(s), sensor(s), in connection with the CPU controller) disposed in a portion of the housing or on the panel enables communications with external devices and the computer controller as to access point device commands for and status of at least one of the package and the movable panel.

The block diagram of FIG. 5 shows certain electronic and mechanical components of the access point device. In an embodiment, the one or more actuators 130 may comprise, by way of non-limiting example, one or more stepper motors, such as NEMA-17 stepper motors and drivers, toothed gear and rod motors, fluid-based or hydraulic actuators, magnetic actuators including solenoids, servo motors, and the like. Computer controller 160 may be configured as a computer processor (CPU) or microprocessor controller, FPGA or custom PCB, with memory 164 (e.g. RAM, ROM, cache, etc.) including computer instructions for execution and functionality, as well as storing identifier information associated with the specific access point device. Additional identifiers (IDs) associated with other access point devices, networks, drone carriers, their authorizations/restrictions, as well as user information and mapping information may also be included. Sensor(s) (labeled generally as 150) may include one or more proximity sensors, motion sensors, infrared (IR) sensors, ultrasound sensors, imaging cameras, and the like, for detection of the carrier within a predetermined area, and/or for detection of a package crossing over or traversing into/out of the aperture of the access device. Controller 160 is communicatively coupled to the one or more sensors and actuators in order to receive and transfer communications signals and commands to these components.

In an embodiment, the controller is configured to generate a control signal to cause the actuators to open the panel in response to detection by a sensor of the carrier, and/or based on authentication of the carrier as authorized for entry to the access point device, so as to enable receipt of the package into the internal housing structure. The controller may receive one or more signals indicative of a detection from the sensors and then relay information to the motors.

For example, in a process for “opening” an access point device embodied in a window, door, drawer or other multi-use structure (generally termed “window” for purposes of this description), when a drone carrier approaches a delivery destination (e.g. access point 200b in FIG. 6), communications may be established between the drone carrier and the particular access point device. The access point device may receive the drone carrier ID information and forward to a web server 800 for association and determination as to whether the drone carrier is to be authorized/verified for package delivery to that device. If authorized, the web server may send a command signal to the device controller 160 to cause actuation by actuators 130 for opening the window. When the window is “opened”, the controller initiates a timeout period TP for closing the window. That is, at the end of the timeout period, the controller causes the window to close, and updates the window status. According to an embodiment, the controller may also “listen” to determine whether an IR sensor signal is broken. That is, an IR sensor may be positioned on the frame or panel for sensing a threshold location (e.g. along axis A) associated with the window aperture. When a package moves past the threshold location (e.g. Aperture A) associated with the open window, the IR signal is broken, which causes the controller to signal the actuator to close the window in advance of the timeout period TP.

Communication hub 170 may be disposed in a portion of the housing or on the panel and enables communications between the computer controller 160 and external devices. Further, communications may be enabled as to status of at least one of the package 10 and the movable panel 120. Authorization of a given carrier may be established via communication of a unique ID of the carrier desiring access to a particular access point device (e.g. 200a, 200b, 300a, 400a in FIG. 6), and comparison with a data base or lookup table containing authorized carrier IDs and related information (e.g. time schedules) associated with the particular access point, in order to proceed with the opening of the movable panel for package delivery.

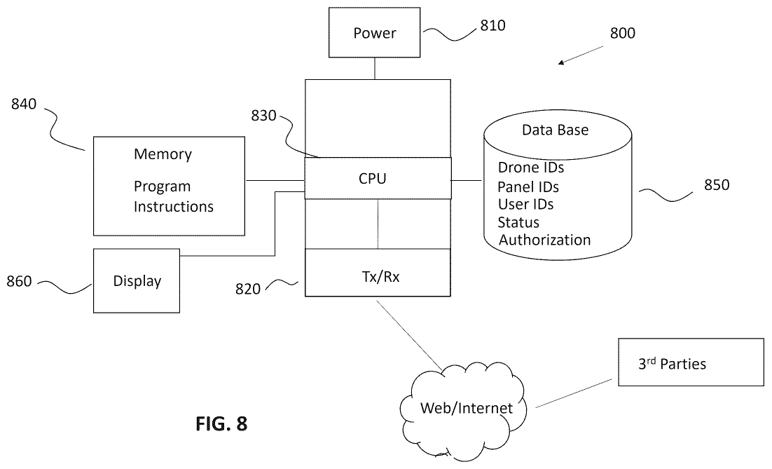

The control processor receives information signals from the one or more sensors, and also communicates with a web server 800. The processor operates to send the status of the window (e.g. “open” or “closed”) to the server and listens for commands from the server. In this manner, an authorized user can remotely determine whether a window is open or closed and can also remotely actuate the window. In one example, a web app may be downloaded onto an external device 430 such as a smart phone or other computer device and can be in communication with the access point device. A unique identifier or code associated with the access point device may be stored in memory 164 for use in verification and/or communication. Dynamic data base updates and listings of unique identifiers and mapping information associated with drone carriers, access panel devices, locations, status, and authorization, may be stored in web server data base 850 (FIG. 8)

In an embodiment, a data base or table containing unique identifiers for each access point device may be stored, for example, in the web server. Each UID is associated with the particular access point device, and corresponding authorized user/owner. A geolocation (e.g. 2.5D or 3D mapping location) may also be associated with each UID, such as GPS latitude/longitude coordinates, along with more precise mapping of elevation, and/or azimuth coordinates, geographic features, and the like. Precise geolocation mapping data associated with each UID (each access point device) may be stored in a separate data base and/or separate secured server (e.g. third parties 500), and accessed/updated by the web server as needed.

In an embodiment, the system may further contain or associate a data base or table listing of identifiers (e.g., carrier identifiers or carrier IDs) of drones who are authorized/authenticated to access a particular access point device. Such authentication may occur at various times, including, for example, upon initialization of an order, and/or upon drone encroachment and detection by a particular access point device sensor, prior to opening of the particular device portal. Verification may be established, for example, by means of internal communications from the access point device and comm hub advising as to detection of a drone, communications from the internal network to a third party (e.g. the drone provider) requesting status and/or particular information related to verifying a given drone proximity and/or coordinates, and upon verification/validation of requested information from the third party as to the particular drone. Communications may then be relayed from the third party to the comm hub or web server, and to the control processor of the particular access point device to proceed with opening. The controller and electronics associated with an access point device may also include electronics for establishing communications with the drone and/or a third party to perform verification/validation/authentication processing. Based on the results, the controller causes the actuator(s) to open or close, or to remain opened/closed based on the results of the verification/authentication.

By way of non-limiting example, user registration may occur upon command from a user device (e.g. smartphone) to a given access point device via a user app. This includes registration of the user device credentials, including but not limited to device type, unique device identifier (ID), user ID, MAC address, IP address, device nickname, and the like, so that the user submits (e.g. pushes) the device ID to be registered with the particular user. Communications between the user app and the web server may be accomplished such that registration and association of the user with particular access devices, as well as association with drone and/or drone carriers (e.g. (A) FEDEX, (B) AMAZON, (C) UPS, etc.) and their verification requirements (e.g. authorized to automatically open access device XYZ upon verification of drone carrier (A); user notification and approval required prior to opening access device XYZ upon verification of drone carrier (A). Similarly, registration for objects such as pets and pet collars or other devices is performed in analogous fashion, namely via a mobile device (e.g. 430 in FIG. 5) and Bluetooth communications for adding and linking the pet/collar with the particular user/owner and particular access point device(s). (e.g. register access point device with collar and on app link the collar and pet).

In a preferred embodiment, data is not saved or stored on the app, but fetched from and updated to the web server. In an embodiment, package delivery may be initiated by a carrier signaling a given access point device, or being detected by and communicating with the access point device. The device forwards the carrier information (credentials) to the web server for authentication/verification. Such carrier credentials include, by way of non-limiting example, one or more of carrier name, carrier ID, order details, order date/timestamp, and the access point device assigned to the order, which information is then forwarded to the web server. In an embodiment, the web server may compare the received carrier information with information stored in its data base to verify whether or not to allow access to the particular device. The web server also operates to determine whether auto delivery is on for that carrier. If so, the web server may send an authorization command to the access point device controller to cause the device controller to command actuators on the device to activate and open the panel to receive the carrier package. On the condition that the web server determines the carrier is not verified for auto delivery, then processing may proceed by means of a notification signal from the server to a user device (e.g. smartphone) via the user app to request instructions for the user to accept/reject the delivery. A reply in the affirmative is a reply that is sent from the user app directly to the access point device IP address to cause the access point device controller processor to open the panel on the device and allow receipt of the package. This direct communication also keeps the web server from being flooded with traffic which may slow down the system. A negative reply will result in no action (i.e. no opening) by the access point device. Device controller 160 will update its internal status for communication to the web server 800.

Sensors 150 may include one or more motion sensors, PIR sensors, radar transceivers, imaging cameras, or other sensing arrangements for determining the presence of a carrier within a predetermined region or distance from the access point, and/or determining the presence of a package within a particular location. More specifically, the one or more sensors may include ultrasound, IR, Bluetooth, WiFi, as well as RFID and QR codes which are part of the overall communications hub of the device. It is understood that various sensors may be disposed at different locations according to their function. By way of non-limiting example, a PIR sensor may be positioned in a portion of the frame or panel to detect motion emanating from outside of the access point device indicative of a carrier and/or package having approached the device within a given detection region. A separate IR sensor or an ultrasound sensor may be positioned in a separate portion of the frame or panel for detecting whether a package has crossed a given threshold corresponding to the window/door/drawer aperture, after the window/door/drawer has been opened. One or more additional sensor(s) including a motion camera or other camera/video/AI camera sensor may also be utilized, either alone or in conjunction with one or more of the IR, PIR, ultrasound sensors, for providing additional detection and determination with regard to drone/package detection, location, and/or identification.

In addition, the system of the present disclosure may establish communications between the drone itself and the device, in order to verify access by the particular carrier prior to opening of the movable panel. That is, the carrier (e.g. aerial done) may not only be required to align itself with a given portal, but also establish communications with and provide one or more authorization codes such that the access point device and/or web server verifies the carrier as authorized for entry, prior to enabling the movable panel to open to receive a package. This may comprise communications between the communications hub and network web server for verifying access to the particular access point device, as well as commands to the device to open access upon verification.

In an exemplary embodiment, communications may be via web page communications, including the internet or via an intranet for internal communications within the system.

### Web Server Configuration

Referring now to FIG. 8, there is shown a schematic representation of a web server 800 according to an embodiment of the present disclosure for enabling mobile node expansion of the network when multiple access point devices, sensors, and the like are connected and installed at various locations within a given geographic proximity or region. The devices are configured such that they are to be connected together for wireless communication. A power source 810 powers the web server. The power source may include one or more solar cells (e.g. lithium-ion or flow batteries), as well as lead-acid batteries or power grid electricity by way of non-limiting example. To span appropriate geographic regions, relay messages between devices may be implemented, wherein each device comprises a unique ID and use radio transmitters/receivers 820 (e.g. LoRa radio) controlled by means of CPU controller 830 (e.g. raspberry pi (zero, etc.) Jetson Nano, Asus, etc.) with executable instructions 840 stored in memory to process, send and receive data., A data base 850 or lookup table containing unique identifiers associated with each of the access point devices, authorized drones/carriers, users, objects, IDs and mapping data which maps the drone/carrier authorizations, access point devices, locations, user/user app associations, passwords, as well as access point status (e.g. open/closed), and other status indicators (e.g. drone/device offline, user authorization required, user override status, etc.) of access point devices, may be stored and updated in real time, as well as displayed on a display device 860 to authorized users/operators. A spread spectrum communication technique (e.g. LoRa) may be used to communicate and send commands/requests to access point devices, user apps, and/or third parties. It is understood that other communications techniques may also be used, including but not limited to frequency-hopping or direct-sequence spread spectrum communications. Web servers such as Apache HTTP server, Microsoft IIS, Nginx or other such web servers programmed with the functionality as described herein may be utilized according to embodiments of the present disclosure.

### Package Detection Processing

Referring now to FIG. 32, in conjunction with FIGS. 5 and 8, there is shown a flowchart illustrating an exemplary process executable by the access point device controller 160 for managing an access port (window) with PIR and package detection, and which interacts with a web interface for updates and command reception. In an embodiment:

Block 1. **Start**:

System Initialization
System processing begins by initializing all connected components. This includes establishing communications (e.g. Direct USB, WiFi, or BLE) and configuring input/output pins for connected components, including, sensors (e.g. PIR, IR, ultrasonic, camera), or other components (e.g. Al analyzers) or sensing elements.

Block 2. **Device Setup**:
Each device (including the motors, sensors, and/or additional components) is configured with specific parameters:
motor pins are set.
speed and acceleration of stepper motors are adjusted.
sensors (e.g. PIR, IR, ultrasonic, camera) are initialized to monitor motion and detect package interruptions.
newly added components to follow similar initialization, with input/output configuration.

Block 3. **Main Loop Execution-Continuous Main Loop Monitoring**:
Once initialized, the system enters a main loop that continuously checks for:
(a) sensor inputs.
(b) incoming commands from authorized devices (e.g., mobile apps and/or web-based commands).
(c) device statuses to manage interactions. (e.g. opening, closing, offline, etc.).

Block 4. **Command Handling**:
If a command is received (e.g. ‘OPEN_WINDOW’, ‘CLOSE_WINDOW’, ‘STATUS’, or other commands from the user app or web server), the system processes the command and executes the corresponding action.

Block 5. **Command Execution**:
Based on the received command:
(a) e.g. ‘OPEN_WINDOW’ or ‘CLOSE_WINDOW’, the controller triggers the motors to move to their respective positions (open/close).
(b) e.g. ‘STATUS’, the controller triggers response with the current state of the system/particular device (opened/closed).
(c) commands for additional components follow similar action pathways, activating respective hardware. For example, other commands such as increasing (or decreasing) processing speeds, timing windows, or additional sensing or verification actions.

Block 6. **Motion Detection via PIR Sensor or other Initializing Sensor**:
The initializing sensor (e.g. PIR sensor or other sensor (e.g. vision camera) configured to detect the presence of a carrier and/or package) monitors for motion. If motion is detected and the window/door/drawer is closed, the system will trigger the actuators (e.g. stepper motors) to open the access point device window/door/drawer.

Block 7. **Package Detection via IR Sensor**:
The IR sensor (or ultrasonic sensor) checks for the presence of a package within a given threshold area. If a package is detected, the system logs the detection, and based on the state (open window/door), allows for processing to proceed to the next step.
For the addition of new sensors for other types of detection, such sensors are integrated similarly, influencing the timing of closing or triggering other actions.

Block 8. **Automatic Management of Devices**:
The system manages automatic actions based on the status of sensors and commands.
For example, if a package is detected, the system may start a timer countdown to automatically close the window/door after a set interval.
For additional devices (e.g., drawers or smart devices), logic will apply: a delay or automation triggers their movement or action based on sensor inputs or commands.

Block 9. **Device Opening with Motors**:
Upon command or sensor trigger, the stepper motors are activated to move the device to the “open” position. The time of this action is logged (e.g., for automation, such as smart timers).
Newly integrated devices follow a like motor control procedure, with tailored motion logic as per the detection and processing requirements.

Block 10. **Device Closing with Motors**:
The motors are activated to “close” the device when certain conditions are met (e.g., no package detection, end of a set timer, or upon receiving a specific “close” command).
A timer delay (pirReactivationDelay) is implemented to prevent immediate re-triggering of sensors during operation. This delay can also apply to new devices as needed.

Block 11. **Sensor Reactivation**:
After a predetermined time delay, the PIR sensor (or other additional sensors) is reactivated, allowing the system to resume monitoring for external motion or other environmental triggers.

Block 12. **Status Communication**:
The system is configured to respond to status requests via communication protocols (e.g. serial communication). On receiving a status command, the system reports out the current state (e.g. open, closed, etc.).
As new devices are added, their statuses are incorporated into the system architecture and responses.

Block 13. Continuous Loop Restart**:
The loop completes and resets to continuously monitor for new commands, sensor inputs, or status changes.
Future commands, devices, or features may be added without affecting the core functionality of the system.

As shown, the system integrates detection (e.g. motion detection) for automatic window opening, package detection for intelligent window management, communications (e.g. serial comm.) for remote control, and status feedback for monitoring purposes. As additional processing, carrier ID verification may be implemented by means of sensor detection and communication of a QR code, ID code, or other such identification mechanism, and comparison with a data base or lookup table or authorized IDs and timing sequences to validate the particular carrier, prior to initiating the opening command for opening the window for receipt of a package.

The following describes the methodology and process steps associated with the installation and operational phases of the access point for autonomous deliveries according to the present disclosure.

### Installation Methods

a. Mobile carrier (Drone Door) Global Mesh Network
b. Plug and Order—User will schedule a survey and or survey and installation.

The installation process associated with install of the access point will require preflights, and test deliveries to create an additional (3d path) to the movable panel (e.g. window) to allow different delivery companies and autonomous delivery vehicles to accurately deliver to the window.

A delivery company can use standard GPS systems to reach a given distance (e.g. a 60-meter radius) of the home location of the access point device (window). From there, a separate client network (GeoMap) may need to be accessed.

Within the GeoMap network, multiple GeoPaths may be made per “window” (i.e. access port device), to allow ADVs to reach the window efficiently.

To join the network, delivery companies may provide one of each type of ADV for use, in order to enable to pilot, perform test deliveries, and integrate into the present system. The relative geo-information may be shared with each company or entity on the client network.

### Operational Methods

### Communications

i. Intra-system communications (e.g. device to device company)
1. client devices to provide periodic updates via the commhub on their security, delivery, open/closed status, etc;
2. certain delivery operations will be performed and communicated with the device.
ii. Drone door device to 3rd party delivery vehicles and companies
   1. Security protection systems (e.g. cybersecurity and communications security) may be established to ensure communications between 3rd party companies and processes for sharing information are secure and protected.
iii. Drone door device/Company to user account (e.g. user Amazon account)
   1. communication handshaking network between Amazon, communication hub (company), device, and the customer
iv. Internal GeoMap Network
   1. Process of mapping the 3d location of each access point device is to be known as GeoPaths. These paths allow ADVs to easily access each access point from multiple angles, depending on the situation.
   2. The collection of GeoPaths will be known as the GeoMap and will be shared with onboard companies, on a need-to-know basis, to allow delivery to the access point devices.
v. Delivery Operations
1. performing deliveries, processes, and communications.

### Window Panel Variations

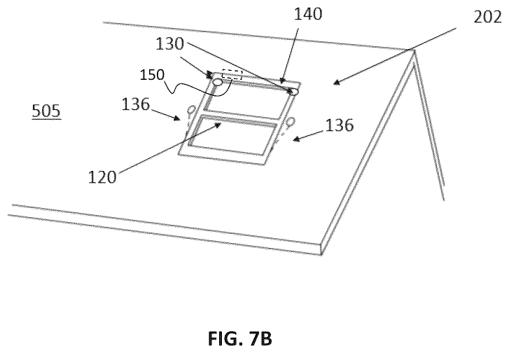

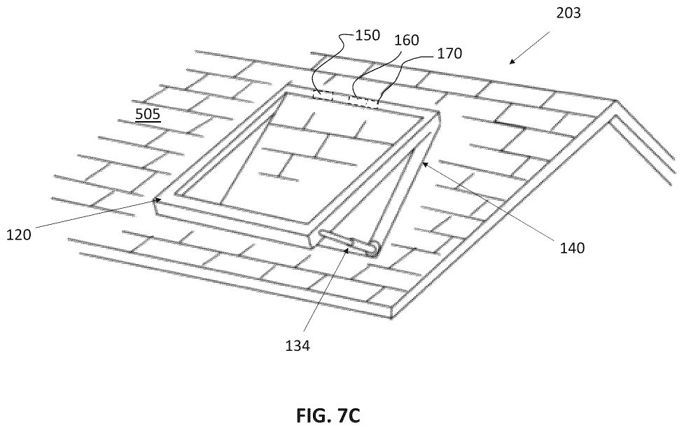

FIGS. 7A, 7B, and 7C depict different variations associated with an access point device that can be placed on a roof as an opaque opening or aperture as a multi-functioning device, or acting as a window or with similar attributes to a window, according to aspects of the present disclosure. As shown in FIG. 7A, access point device 201 is disposed on the roof enclosure 505 of a building and includes panel members 120a, 120b, 120c, 120d, that move about a pivot point Pt1 to open and close, as generally described herein with regard to FIG. 9. The actuators, sensors, and electronics (not shown) are disposed within the frame housing and/or the edges of the window or panel 120. As shown in FIGS. 7B and 7C, the actuator 130 may be embodied as a motor operative for controlling movement of the window (e.g. based on commands from the controller and responsive to sensors (not shown) for detection of an aerial drone device, as well as authentication of the drone). The embodiment of FIG. 7B shows device 202 further illustrating a spring structure 136 on at least one or both sides of the window frame 140 to provide a controlled fall of the window panel 120. FIG. 7C illustrates a similar structure 203 but utilizes a hydraulic actuator 134 disposed on or in the window panel 120 or frame 140, to raise, lower, and/or maintain/support the window in an open or closed position, in response to control signals from the controller.

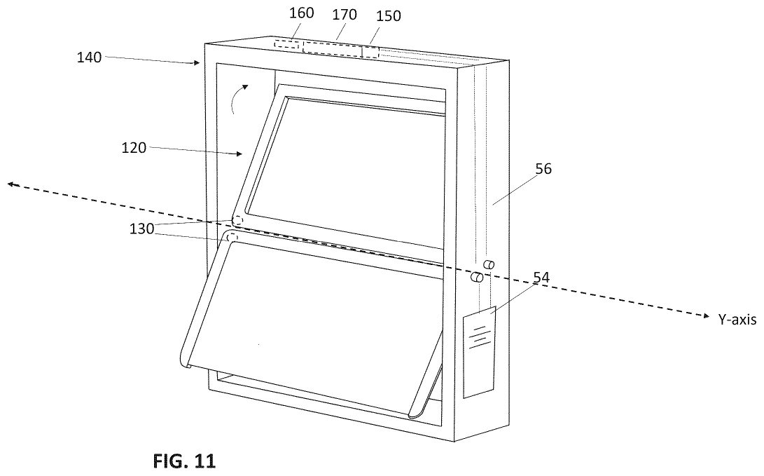

Referring now to FIG. 11, there is shown an embodiment wherein motors 130 are arranged within the moveable window panel(s) 120 in relation to the fixed window frame 140 to turn the windows about a central axis Y. This access point configuration of window panels forms a chute for receiving and conveying packages into an enclosure, according to an embodiment of the disclosure. As shown, the electronics components 170 (e.g. solar cell, WiFi, Bluetooth, rfid, QR, etc.) are embedded within the frame housing 140, although it is contemplated that they may be embedded within moveable panel 120. A power source 54 such as a battery supplies power via wire connections 56 through the frame to the electronics components 170. This arrangement may advantageously be configured to fit a smaller aperture location.

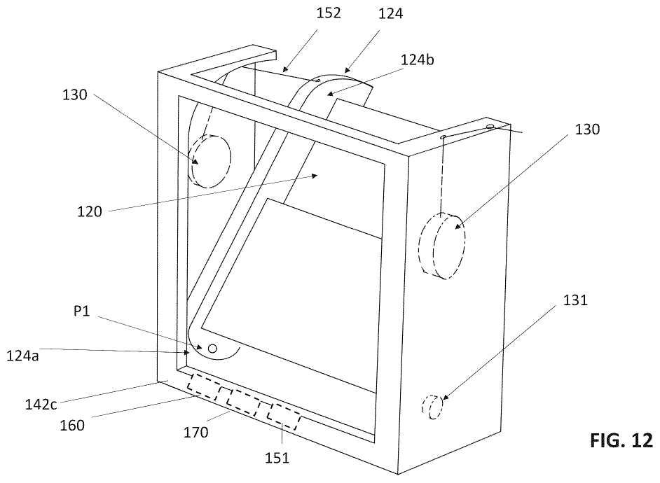

FIG. 12 illustrates a combined or unitary frame and window embodiment of an access point device wherein a drawstring 152 is operatively coupled with actuator motors 130 to pull or relax the drawstring, and motor 131 to turn the window and raise and lower the window frame fixed about a pivoting point P1. CPU Controller 160 and comm hub electronics 170 along with sensors, such as one or more IR sensors 151, are disposed at the bottom most portion at frame section 142c. As shown, support 124 coupled to panel 120 is pivotally movable by means of the drawstring 152 and pivot point arrangement. In an alternative embodiment, actuator 130 is operative to both pivot and open and close the panels. As shown, support 124 is curved at opposite ends as shown by lower curved support portion 124a and upper curved support portion 124b so as to assist in the gravitational fall of the window and relieving the amount of torque required and assisting in the pivoting action, in contrast, for example, to a ball bearing and rod configuration.

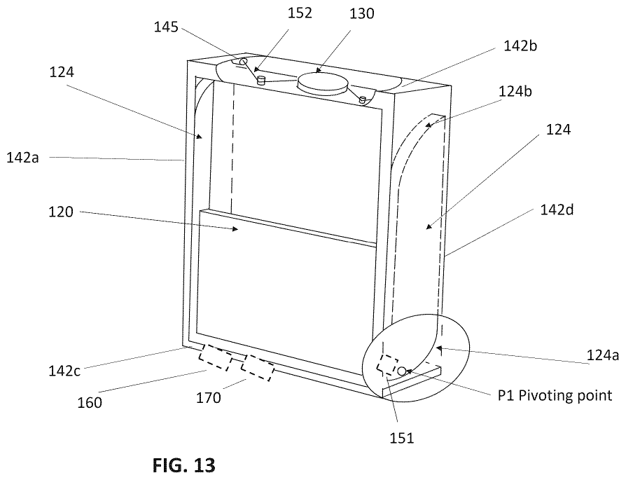

FIG. 13 depicts a variation of the embodiment of FIG. 12 that explores different corners, pivoting designs, and drawstring mechanism designs. As shown, wire 152 is operatively coupled to supports 124 of panel 120 and actuator 130 positioned within a top portion 142b of frame 140 to controllably adjust the pulley tension in the wire. As illustrated, the pulley tension system has its wires coupled through the actuator motor and the interior of the frame including opposing frame sides 142a, 142d, via apertures 145 to move support 124. As previously described, data processing electronics may be embedded in the bottom portion 142c of frame 140. IR sensor 151 may also be positioned in the bottom portion of supports 124 or frame 142c to detect and initiate early window closure in advance of the timeout period as previously discussed.

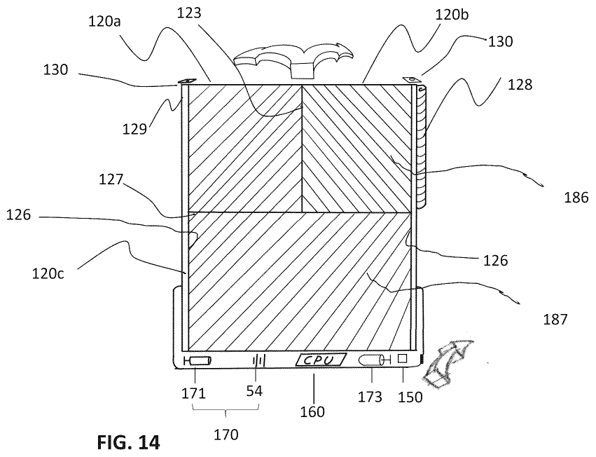

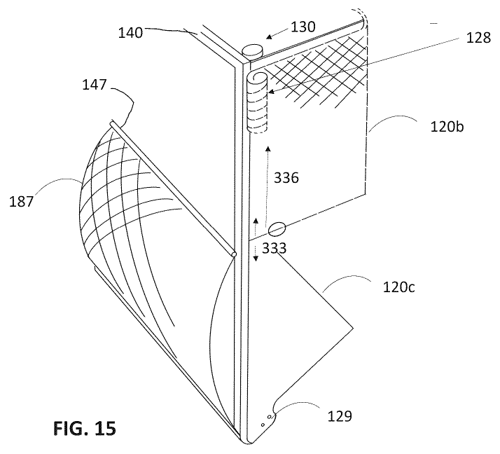

FIGS. 14, 15 and 16 illustrate a three-panel configuration wherein a pair of upper side panels 120a, 120b, open laterally while a lower retractable panel 120c with mesh layer moves in drawbridge-like fashion to support receipt of a package. A mesh reel 128 is positioned on a window side surface with a spring coil arrangement. A fixed mesh joint 129 is disposed opposite the mesh reel. A slider or pivot rod 127 for the lower mesh is disposed between the bottom of upper side panels 120a, 120b and lower panel 120c for vertically sliding the lower mesh by means of grooves in the interior frame portion (not shown) and ball bearing or other means. One or more actuators or motors 130 are positioned on the top portions of panels 120a, 120b, while a smooth barrier 123 (e.g. a plastic tubing) separates the upper panels. A channel 126 for the retractable mesh layer 187 associated with panel 120c is also provided. As shown, the electronics and power components 170, including one or more solar regulators 171, rechargeable battery packs 54, stepper motors 173, sensor(s) 150, and CPU 160, are disposed within a bottom most portion of the window frame (hollow) and/or housing. The motor 173 sits on the frame 140 with a hollow connection to the window panel, and is operative to move the mesh upward when closed and releases when opening, thereby providing space in which to catch the package.

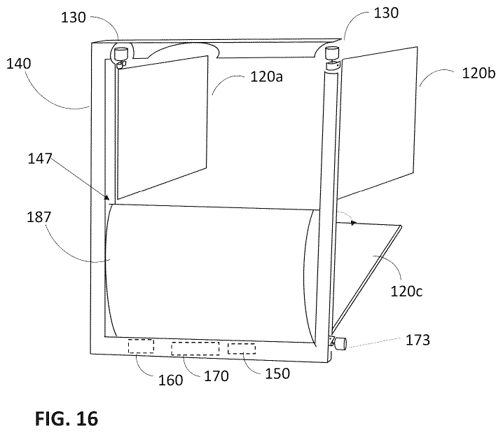

As best shown in FIG. 16, the upper side panels 120a, 120b operate to be opened/closed so as to enable receipt of (and retain) the packages. The panels have an associated mesh fabric structure positioned within the aperture with the mesh held upright via the long spring coil device on the panel frame 129. The lower panel 120c is operative to pivot in drawbridge-like fashion to open the device in response to controller 160 commands. The associated mesh fabric 186 and 187 are positioned within the aperture behind upper side panels (120a, 120b) and lower panel 120c, respectively, to catch packages entered into the window.

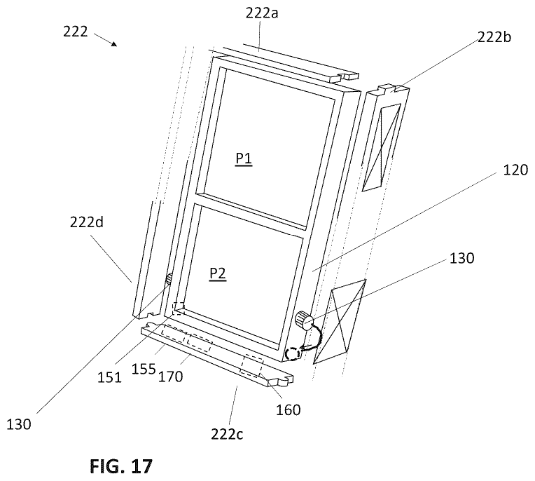

FIG. 17 illustrates an embodiment wherein multiple motors 130 are used at a pivoting point to leverage the window. As illustrated, FIG. 17 shows a window comprising a standard single or double window structure with panels P1, P2 in which an access point device is embodied. As is understood, the window may be inserted into or formed in a building enclosure. Detachable/reattachable frame panel members 224a, 224b, 224c, and 224d are configured to surround the exterior of the standard window. Motors 130 such as a gear locking motor for frame engagement, whereby the motor in the frame turns a gear attached to the window for opening/closing only the bottom half (P2) of the window panel, and electronic circuitry 170 such as communication hub for transmitter/receiver circuitry and CPU 160 controller electronics. Battery 54 is illustrated within the frame structure and configured to power the access point device. IR sensor 151 is illustrated as embedded within the panel for detecting whether the package has passed the window threshold for receipt in the enclosure.

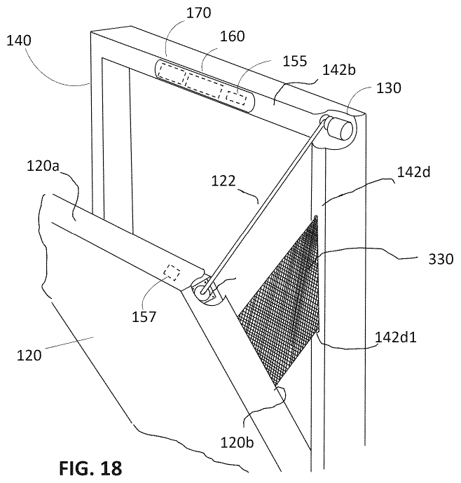

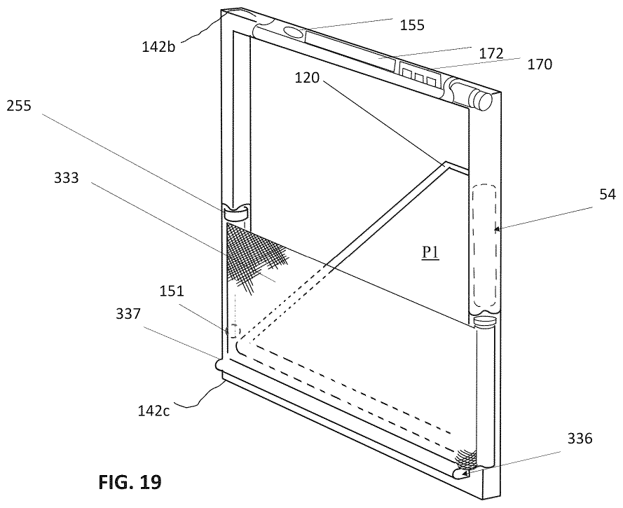

FIGS. 18-19 illustrate further detailed versions of embodiments shown in the preceding figures. More specifically, akin to the embodiment illustrated in FIG. 9, FIG. 18 shows an access point device having motor 130 operatively engaging with wire or string 122 for controllably opening and closing window panel 120. String anchoring device 123 maintains wire 122 within the panel structure. Side mesh 330 is connected between a frame portion 140 and movable panel portion 120 for inhibiting inadvertent side entry/exit of the package and maintaining overall package safety upon entry into panel 120. As shown, one end of mesh 330 is received into slit 142d1 formed on an outer portion of frame section 142d. An opposite end of mesh 330 is similarly received into a slit (not shown) formed on an inner portion of panel section 120b. Side mesh 330 is likewise disposed on the opposite side of the window frame structure shown in FIG. 18. Electronic circuitry 170 including the communication hub for transmitter/receiver circuitry and CPU controller electronics, power source 54 such as a solar panel, and sensor(s) 150 such as a motion sensor/IR sensor may be embedded within frame section 142b. A further detection/authentication device such as a QR code 157 to assist in drone positioning may also be implemented on a portion 120a of the movable panel 120. The IR sensor may be embedded within the frame or panel for detecting whether the package has passed a window threshold region for receipt in the enclosure.

FIG. 19 shows additional details relating to positioning of the retraction and release mechanism for mesh 333 including a storage compartment 336 for the mesh as well as the coil system 255 for the mesh. Storage structure 336 is configured with a lip portion 337 which extends slightly above the bottom of panel 120 to reduce package speed upon entry into the enclosure, when a package is placed onto the surface P1 of panel 120 and slid into the enclosure. Electronic circuitry 170 including the communication hub for transmitter/receiver circuitry and CPU controller electronics, such as a solar panel 172, and sensor(s) 150 such as a motion sensor/IR sensor may be embedded within frame section 142b and/or 142c.

### Drawer Panel Configuration

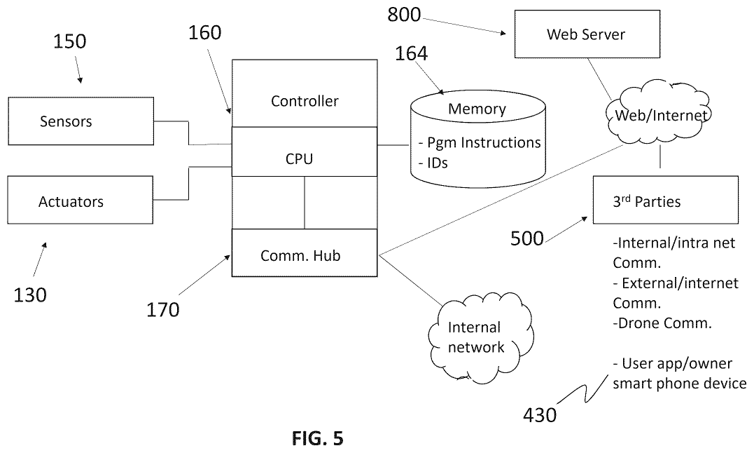

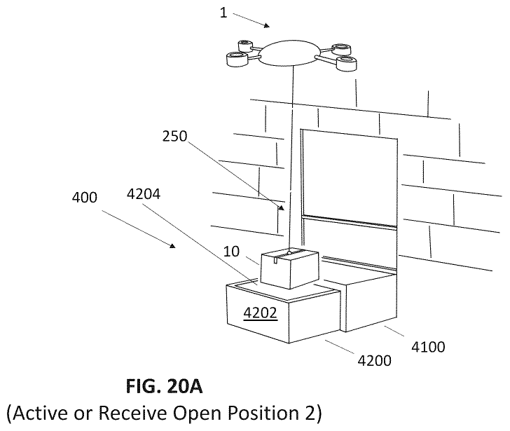

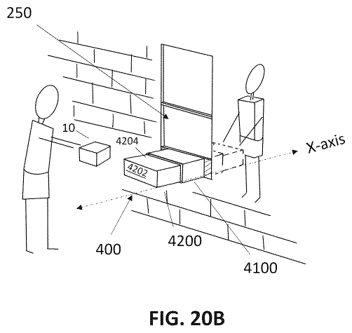

Referring now to FIGS. 20-25, there are shown additional embodiments of access point device configurations akin to FIG. 4 according to aspects of the present disclosure. In these embodiments, the access point device can be removably inserted into standard openings (e.g. a window) in a plug-and-play design. Such plug-and-play design comprises a housing coupled with a movable panel member in the form of a built-in or slidable drawer, capable of autonomously extending along an axis (e.g. horizontal axis in two directions). As best illustrated in FIG. 20A, 20B, the drawer in the container will extend horizontally away from the housing that the device is installed in to an “open” position to receive deliveries. A “closed” position of the drawer will close off the orifice to both ingress and egress (internal and external). The drawer can then extend/retract into the housing, allowing a user inside the enclosure (internal) to receive the package, while maintaining the drawer as closed to the outside (external) of the enclosure. This version may utilize like components as described herein with respect the embodiments shown in FIGS. 2-19. In exemplary embodiments, one or more additional PIR sensors, may be used in addition to, or in place of one or more IR and/or ultrasonic sensors. The controller CPU, electronics commhub, and the one or more sensors may be disposed in the housing and/or movable panel drawer akin to the window and drawer embodiments.

As best shown in FIG. 24B, in a preferred embodiment, the drawer configuration comprises a motion sensor or PIR sensor 155 disposed on a portion of housing 4100, such as the top forward end of the housing. An ultrasonic sensor 153 is disposed on the front interior portion of drawer 4200 for detecting the presence of a package upon placement in the drawer cavity 4204. An IR sensor may also be utilized. However, an ultrasonic sensor covers a wider area than the IR sensor “linear beam” and is preferred in a confined space. False detections which are problematic in an open environment are mitigated in the drawer configuration, enabling the package to be dropped anywhere within the drawer and be quickly and efficiently detected.

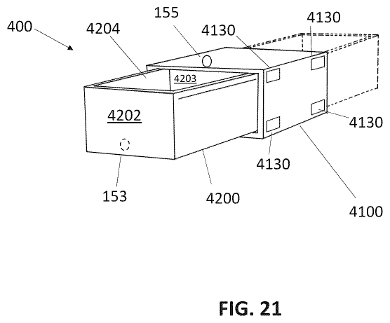

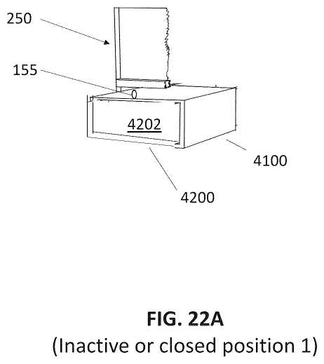

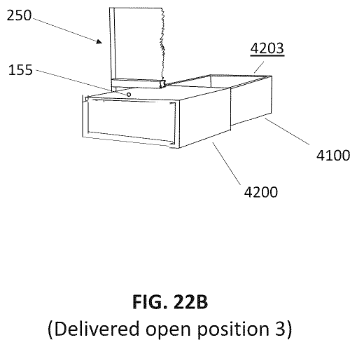

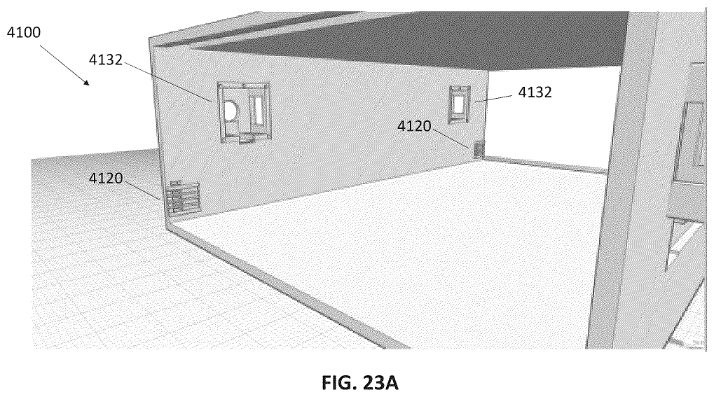

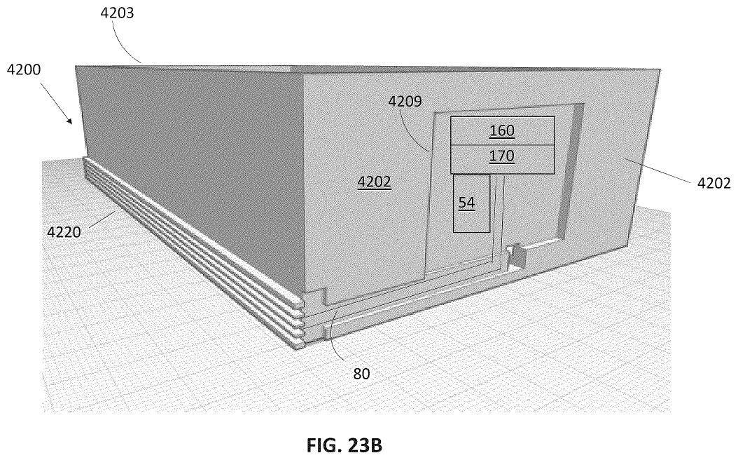

FIG. 21 schematically illustrates the movable or slidable panel drawer 4200 which can extend open to a “receive open” or “active” position, “closed” position, or an “deliver open” position. As shown, access point device 400 comprises a housing 4100 having a slidable drawer 4200 with cavity 4204 defined therein for receiving a package. The exterior of the housing is illustrated as a rectangular structure and adapted to be disposed in any of various standard-sized window apertures, in a manner akin to window air conditioning units, so as to sealingly close the window 250 and prohibit ingress or egress there through. The slidable drawer 4200 is housed within the housing container as best shown in FIGS. 21-25. In an exemplary embodiment, the slidable drawer may be positioned in a first (inactive or closed) position (FIG. 22A) within the housing 4100 such that a first end 4202 of the slidable drawer and the housing within the window completely blocks access to/from the exterior environment such that the access point is in a closed state. FIG. 20A shows the drawer in a second, “active”, “receive open”, position where the device has access to the external environment to receive a package. FIG. 22B shows the drawer in a third, “deliver open”, position where the device has delivery access to the internal environment for package pickup. As best shown in FIG. 20A-20B, the slidable drawer is configured to be moved along the X-axis (e.g. horizontally) to a second (active or receive open) position (Position 2) such that a portion of the drawer 4200 including the first end 4202 extends outside of the housing to the exterior environment and exposes cavity 4202 defined by first end 4202 and second end 4203, lateral side surfaces, and a bottom surface, to receive a package 10 carried via an authorized carrier. Upon receipt of the package into the drawer, or upon expiration of a timer, the program controller 160 (see FIG. 23B) causes actuation of the slidable drawer 4200 to move back to the inactive or closed position (Position 1), and/or further move to a third (delivered open) position (Position 3), such that a portion of the drawer extends beyond the housing to the interior environment and exposes cavity 4202 to thereby deliver the received package at a position for user pickup (see FIG. 22B). At the first and third positions, the first end 4202 of the drawer is disposed in the housing such that it prevents access to the drawer cavity from the exterior environment. At the first and second positions, the second end 4203 of the drawer is disposed in the housing such that it prevents access to the drawer cavity from the interior environment.

As shown, one or more actuators 4130 are configured for moving (e.g. via gear rack, or via pneumatic, hydraulic, or electrical actuation) the slidable drawer in response to instructions from the controller and based on both sensor detection and carrier ID authorization (authentication). One or more sensors are configured for detecting whether a carrier of a package (e.g. an aerial drone) is within a predetermined region or area associated with the moveable drawer, and for subsequently detecting the presence of the package within the drawer and communicating with the controller for causing drawer activation. It is to be understood that the controller electronics as described herein, namely a CPU with memory, communications hub, and actuator motors with capacitors, are configured to communicate with external networks and devices (e.g. web server, user app, drone device, etc.) and to smoothly operate the motors. In an exemplary embodiment, an ultrasonic sensor may preferably be used and positioned within the drawer for detecting and determining whether a package has been placed in the drawer.

Referring now to FIGS. 23A, 23B, 24A, and 24B, there are shown exemplary illustrations of a housing 4100 for an access point device, movable panel drawer 4200 for an access point device, and an access point device 400 with and without a package in the drawer, respectively. FIG. 23A shows electrical connectors 4120 disposed on portions of the interior lateral sides of housing 4100 for electrical connection to the CPU and drawer connector rails 4220 (FIG. 23B) disposed on an interior lateral side of drawer 4200. In an exemplary embodiment, drawer connector rails 4220 may comprise copper strips extending the length of the drawer to thereby enable the electronics and connectivity in the drawer panel. Actuators 4130 for linearly moving drawer 4200 are retained in actuator housings 4132. In an embodiment, the controller CPU 160, electronics 170 and power source (battery 54) may be disposed within a cutout portion 4209 (FIG. 23B) of the drawer and electrically connected (e.g. via traces or wires 80) with the connector rail 4220, which is necessary to electrically connect with electronics (e.g. ultrasonic sensor) built into the moving drawer panel, without the need for obtrusive wire connections.

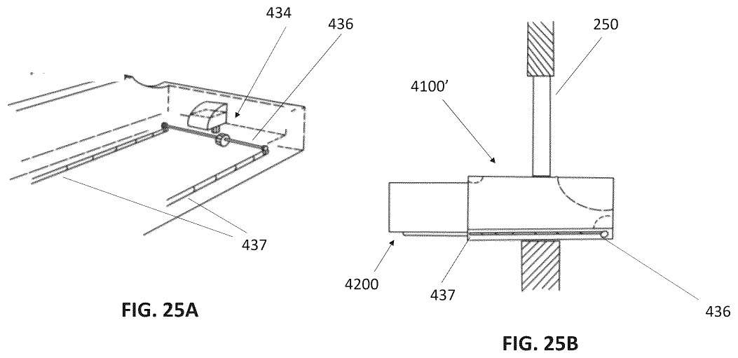

FIGS. 25A and 25B show partial sectional views of a further variation of the drawer 4200′ and housing 4100′ having a lid to open and receive a package. As shown, actuator 434 connects with rod 436 which spirals to push out or pull in drawer 4200′ via rails 437.

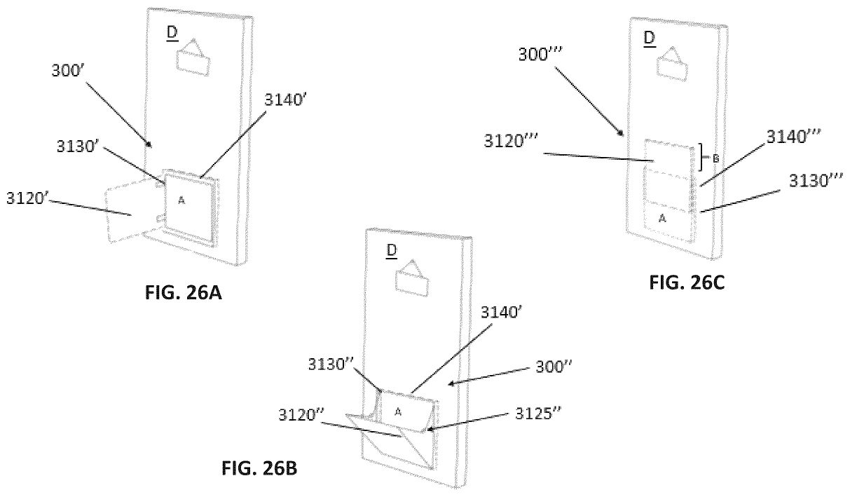

FIGS. 26A, 26B, 26C, and 27-31 depict additional embodiments of access point device configurations akin to FIG. 3 according to aspects of the present disclosure. FIG. 26A illustrates a door variation of an access control device wherein device 300′ is embedded within an enclosure such as a door frame D having aperture A. One or more actuators 3130′ operate to open and close the swing panel 3120′ hingedly coupled to frame 3140′ attached to or embedded within door D. Affixed to or embedded in the frame and/or panel include the CPU controller, comm hub communications electronics, and one or more sensors for detecting at least package entry through the frame.

FIG. 26B illustrates a further door variation of an access control device wherein device 300″ includes pivoting or foldable panel 3120″ similar to a pivotable window configuration with hinge or drawbridge element 3125″ for opening and closing the panel and thereby enabling/disabling ingress or insertion of a package via aperture A. FIG. 26C illustrates a hidden module variation wherein the device 300′″ has frame 3140′″ flush with the outer surface of door D, and vertical actuator 3130′″ operates to vertically open and close panel 3120′″ and thereby enabling/disabling ingress or insertion of a package via aperture A. In this embodiment, the enclosure aperture requires not only through aperture A for receiving a package when the panel 3120′″ is open, but further includes internal cavity B disposed within the door frame enclosure and sized to receive panel 3120′″ when the panel is moved in the vertical direction when opening the access point device, to thereby accommodate the panel.

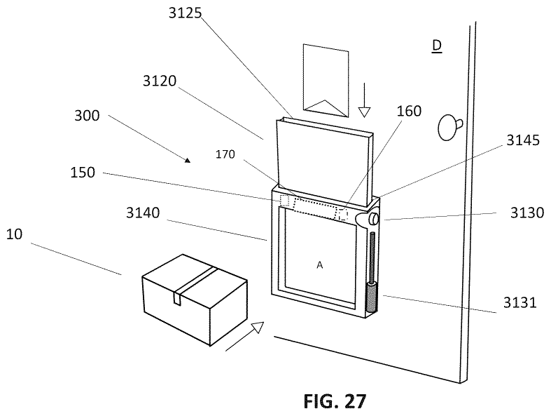

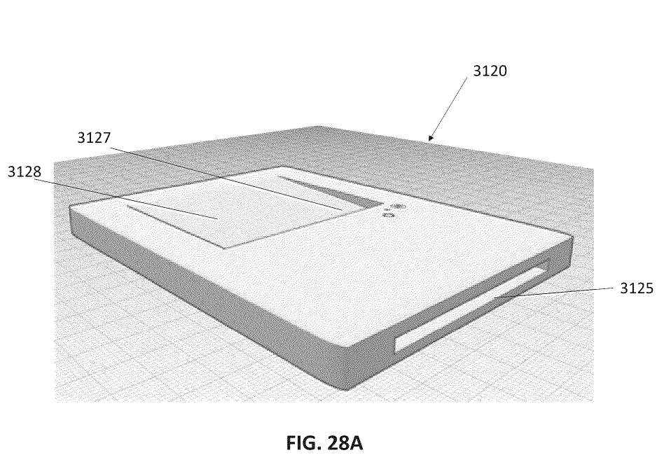

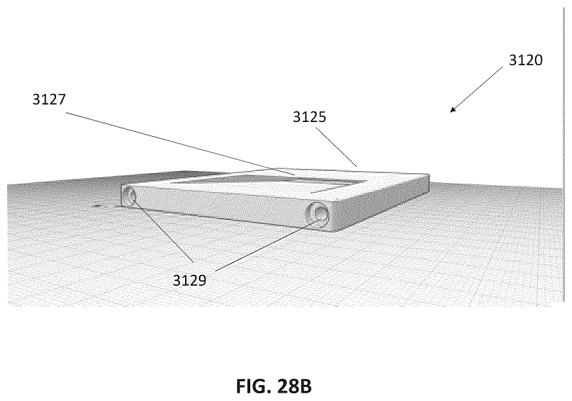

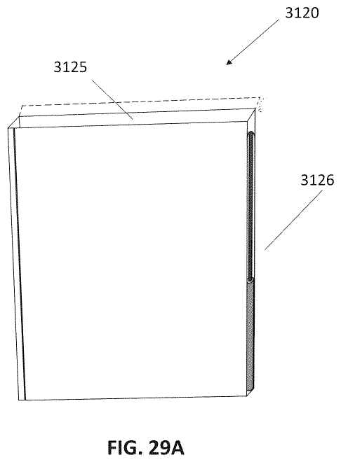

FIG. 27 illustrates a more detailed embodiment of the access point device 300 door configuration of FIG. 3. As shown, the device includes a frame or housing 3140 coupled directly to an enclosure such as a door (D). The frame provides structural support while housing other components of the device. The frame Includes an opening 3145 on its topside which allows movable panel 3120 to move vertically through it during operation. Vertically movable panel 3120 is positioned within the frame and functions as a sliding barrier to open and close aperture A in door D. This structure enables the secure transfer of a package 10 or other items from the external environment into the enclosure. Panel 3120 further includes an open top slit 3125 designed to receive smaller items such as letters for secure retention within the enclosure. Inside the panel, a passageway is formed to guide the inserted items downward. As best shown in FIGS. 28A-28B, the passageway terminates at exit slot 3127 on the interior side of panel 3120 approximately midway down the panel. The exit slot is positioned to allow the letters to drop out and be guided via sloped surface 3128 gently into the interior of the enclosure (e.g. house or building). Motor/actuator connector assemblies are housed in the panel within cavities 3129.

Referring again to FIG. 27, actuators 3130, 3131 are mounted on a lateral side of frame 3140 and controllable via CPU controller 160 for moving the panel 3120 vertically, either upward or downward, to open or close the aperture A. As is understood, the CPU controller manages the operation of the actuators based on predefined instructions/programmable logic and/or remote commands to ensure precise and secure control of the panel's movement. Panel 3120 is preferably opaque and made of a sturdy and durable material to prevent unauthorized access. Frame 3140 may be fixedly secured to the door D about aperture A via numerous attachment means, including but not limited to bolts, screws, nails, adhesives, welding, or other fasteners, as well as integrated into the door during manufacture or retrofitted after installation.

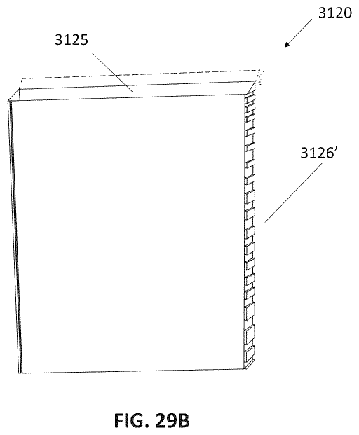

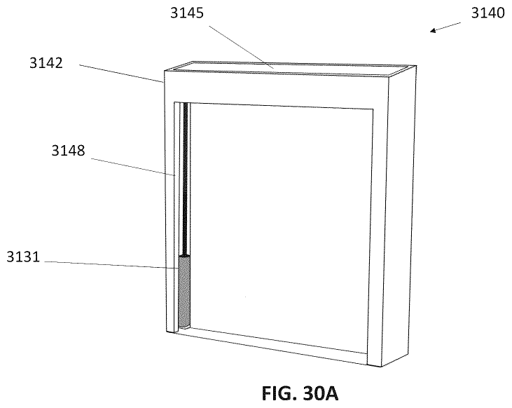

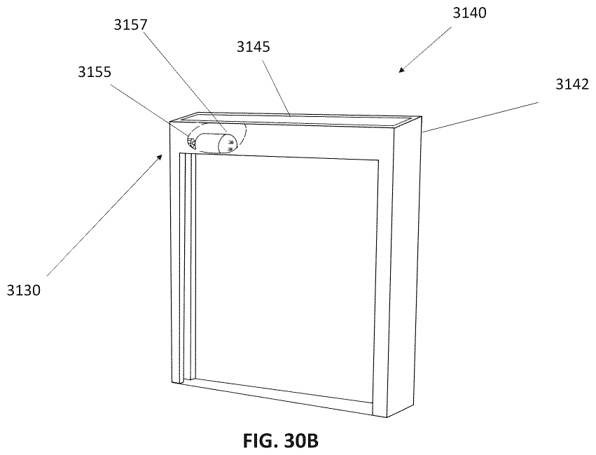

FIG. 29A shows an exemplary perspective schematic view of the exterior side of panel 3120 and connection 3126 for engagement with the hydraulic actuator 3131 disposed on inner rail 3148 of the frame housing as best shown in FIGS. 27 and 30A. FIG. 29B shows an embodiment of panel 3120 having belt connector 3126′ disposed along a longitudinal outer surface with teeth for engagement with an actuator motor (e.g. 3130 of FIG. 27).on frame 3140. FIG. 30B a more detailed illustration of an actuator 3130 in the form of a motor 3157 and toothed gear 3155 arrangement disposed within an interior of frame 3140 for engagement with panel connectors for panel actuation.

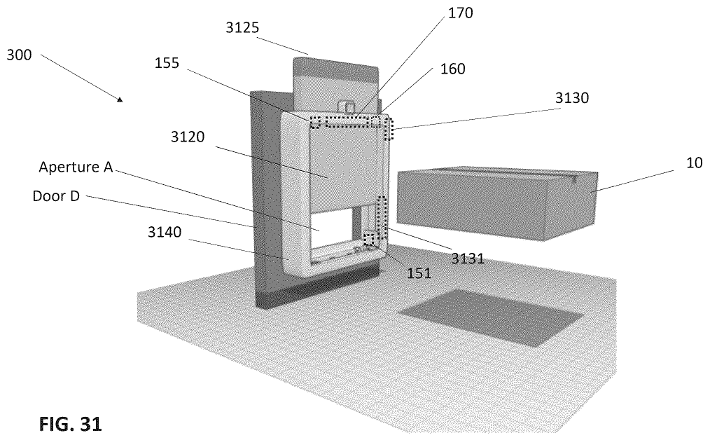

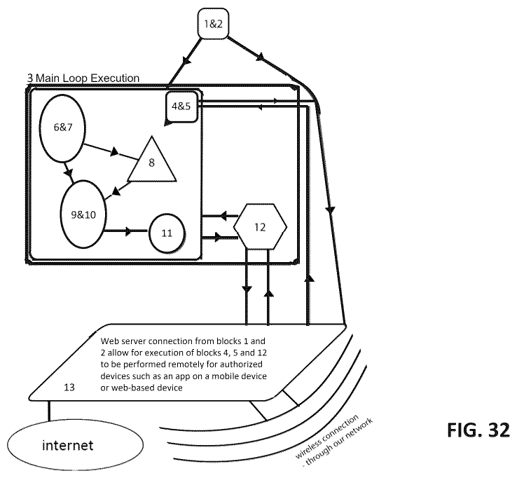

FIG. 31 shows a further perspective view of an access point device 300 door configuration wherein panel 3120 is in the process of opening to receive package 10 through aperture A and into the enclosure.

### Auto-Retrieval Vehicle System

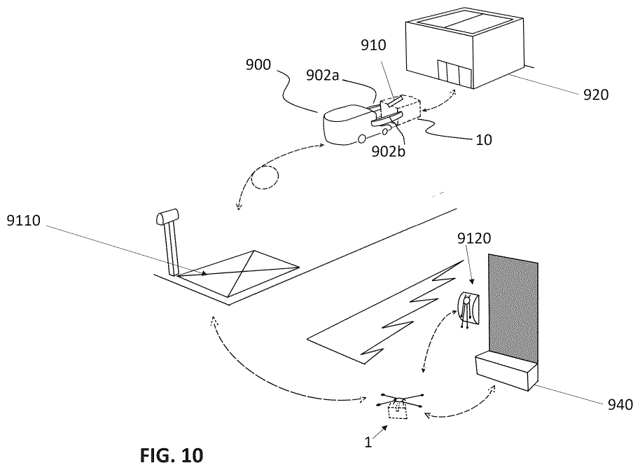

FIG. 10 shows a schematic illustration of a drone vehicle or auto-retrieval vehicle 900 for picking up a package 10 according to another embodiment of the present disclosure. The vehicle print return 910 or mailing receipts for packages are identified on the outer surface of the container 10 and the vehicle operates to retrieve the package from a retrieval facility 920, and drop the package off in a given destination location box 940 according to the packaging details. The vehicle includes arm members 902 configured to spin in both forward and reverse directions to enable retrieval and dispatch of packages from the vehicle. Such arm members (e.g. rubber or other adhesive) may extend both horizontally and/or vertically and/or axially in order to retrieve a given package according to its sensed engagement. It is understood that larger aerial drones can deliver into and drop in the package. Other devices such as mat-like access point device 9110 which may open as described herein to receive/retrieve a package, as well as aerial drone 1, and destination access point device drone 9120, may also be utilized to achieve delivery to required destinations. Such vehicles may be included as part of the network of devices, and including computer processing and memory storage of unique identifiers to recognize which of the access points to take the package.

Thus, there is disclosed a system, method and device that enables completion of the autonomy of a package delivery system. The device may be built in standard sizes for pre-existing openings or apertures for buildings and homes. This will allow for the easy implementation of new alternative access point in many properties and infrastructures. The device is capable of entirely, and autonomously, detecting an incoming carrier (e.g. delivery drone), open itself to receive the package, safely receive the package, and then close itself. The device is secure both physically and digitally such that the device is secure from physical tamper such as theft, forcible opening, and digital attacks such as hacks and/or other electrical interferences. This device may be accompanied by an app that alerts the user of activities and allows the user to view these activities through a built-in camera. The device will also be in communication with a cloud-based network to receive and relay information. Through the cloud network, the device will be able to communicate with third party online warehouses (e.g. Amazon or Walmart), and delivery companies like GrubHub and UberEats. In addition, this device is self-operating and should not need an electrical connector plug or external power source. Thus, in one aspect, the disclosed system and device helps to eliminate at least one human aspect of present delivery systems, making it more autonomous and effective.

Accordingly, there is provided a system configured to support autonomous receipt of packages carried via a carrier comprises: a housing; a movable panel disposed in the housing and configured to automatically open and close an aperture in the housing; an actuator disposed in a portion of the housing for automatically opening or closing the movable panel; a sensor disposed in a portion of the housing or the movable panel for detecting whether a carrier of a package is within a predetermined region associated with the moveable panel; a computer controller disposed in a portion of the housing or the movable panel and communicatively coupled with the sensor and the actuator, wherein the controller generates a signal to cause the actuator to open the panel in response to detection by the sensor to enable receipt of the package into the housing by the carrier; wherein a communication hub disposed in a portion of the housing or on the panel enables communications from the computer controller as to a status of one or more of the package and the movable panel. Authorization of a given carrier may be established via communication of a unique ID of the carrier desiring access to the particular access point, and comparison with a data base or lookup table containing authorized carrier IDs and related information (e.g. time schedules) associated with the particular access point, in order to proceed with the opening of the movable panel for package delivery.

The carrier may comprise an aerial drone. The movable panel may comprise one of a door and a window.

The one or more actuators may comprise one or more stepper motors. In an embodiment, the stepper motor is responsive to a directional signal from the computer controller for opening or closing the movable panel.

In an embodiment, the sensor arrangement comprises a passive infrared (PIR) sensor for detecting motion of a carrier of a package within a predetermined region and intended for ingress to said housing via said movable panel. The sensor arrangement further comprises at least one of a second IR sensor and a video camera, the at least one second IR sensor and the video camera disposed on a frame of the door or the window, and configured for detecting when the package passes through the aperture of the housing, and sends a signal to the controller in response thereto.

In an embodiment, the movable panel comprises a window.

In an embodiment, the movable panel comprises a drawer.

In an embodiment, a pair of stepper motors are each contained within a respective motor housing and embedded in opposite sides of a fixed frame of the window. In an embodiment, wherein each motor housing is also embedded in a portion of the housing.

In an embodiment, each stepper motor is connected to a draw string attached to a portion of the window for opening and closing the window.

In an embodiment, each said stepper motor is connected to a mesh reel which is deployed in response to a signal from the controller so as to catch the package from the drone. In an embodiment, the mesh reel is deployed horizontally across a portion of the window frame, wherein the window panel opens at an acute longitudinal angle relative to the vertical axis to receive and support the package.

In an embodiment, upon detection of the aerial drone and opening of the window, a timer is set to cause the window to close upon expiration of the timer.

In an embodiment, the communications hub further includes a web server to allow remote control and window status.

In an embodiment, upon detection of the aerial drone and opening of the window to receive the package, the controller causes temporary deactivation of the PIR sensor.

In an embodiment, a timing delay is set by the controller to reactivate the PIR sensor.

In an embodiment, the controller receives an identification code from the carrier, and the received identification code is compared with a list of codes stored in memory associated with the controller to determine a match. The controller is operative to maintain closure of the movable panel unless a match is detected.

In an embodiment, an access point device comprises a housing having a slidable drawer therein. The exterior of the housing is adapted to be disposed in a window, and to sealingly close the window to prohibit ingress or egress there through. The slidable drawer is housed within the housing container. The slidable drawer may be positioned in a first (inactive or closed) position within the housing such that a first end of the slidable drawer and the housing within the window completely blocks access to/from the exterior environment such that the access point is in a closed state. The slidable drawer is configured to be moved via one or more actuators according to a control signal responsive to one or more sensors and an authorization/authentication mechanism. Such movement (e.g. horizontally) of the drawer to a second (active or open) position is provided whereby a portion of the drawer including the first end extends outside of the housing into the exterior environment. Extension is made in order to receive a package carried via an authorized carrier. Upon sensed receipt of the package into the drawer via another sensor, or upon expiration of a timer, the slidable drawer is further configured to move back to the inactive or closed position (via the actuator/controller), and/or further move to a third (delivered) position, such that a portion of the drawer including a second end extends outside of the housing to the interior environment to deliver the received package at a position for user pickup. At the third position, the first end of the drawer disposed within the housing serves to maintain the access point in the closed state. The one or more actuators are configured for moving the slidable drawer in response to instructions from the controller and based on both sensor detection and carrier ID authorization (authentication). One or more sensors are configured for detecting whether a carrier of a package (e.g. an aerial drone) is within a predetermined region or area associated with the moveable drawer, and for subsequently detecting the presence of the package within the drawer and communicating with the controller for causing drawer activation. The power, electronics and actuators and sensors are disposed or embedded in a portion of the device drawer and/or portion of the container housing. While the exemplary embodiment illustrates three positions associated with the drawer configuration, it is understood that the system may operate in only two positions (e.g. position 2 or position 3), or may operate in various other partially open positions, the extent of the drawer opening or rail traversal being dependent on the determined size of the package to be received, by way of non-limiting example.

While the foregoing disclosure has been made with reference to the above-described embodiments, various additional modifications and changes can be made without departing from the spirit of the disclosure. For example, while the foregoing disclosure has made reference largely to automated drone carriers and packages for delivery to an access point device embodied within a drawer, window, or door, applications for other deliverables are also contemplated. For example, pets or other creatures may be equipped with communication devices (“packages”) registered or authorized for access to particular access point devices. That is, certain access point devices and associated web servers may have registered and authorized a given package device. The package device may be embedded in a physical item (e.g. collar) worn by a creature, such as a dog or cat, or in a chip embedded just under the skin. In one embodiment, when a pet wishes to come into the home, it may stand in front of a door and wait for a person to open the door. In accordance with an aspect of the present disclosure, a sensor (e.g. a motion sensor or video camera) may detect the presence of an entity within a given threshold distance from the access point device. This detection may trigger a communication from the CPU 160 requesting identification information. If a signal is received containing identification information, the information is forwarded to the web server to determine if authorized to open the access point device. If authorization/verification is determined, a command is sent from the web server to the CPU to cause the panel on the access point device to open. In an embodiment, with vision sensing (e.g. camera) implemented within the access point device, the device may further be trained to recognize select features (e.g. physical characteristics, such as size, shape, facial features, etc.) of particular pet(s) and subsequent access/denial of access to a given device. The device equipped with an AI camera and vision sensor may therefore be configured to “see” and store locally at the device the features and characteristics associated with the particular pet, thereby enhancing and providing a further option and activation mechanism for entry. For example, the motion sensor may detect the presence of a pet and may initiate the camera, wherein the camera in conjunction with the communication hub and signal communications between the device and the detected presence, may come to a faster and/or more effective conclusion as to whether or not to open the device “door”. For example, if motion is detected and the AI camera recognizes the creature as a cat, but does not recognize a collar worn by the cat, or the features of the particular cat as being authorized for access, the access point device would not open the door, or would require greater communications and verification before enabling access. Periodic updates from the local device to the web server as to characteristics, features, and the like for particular creatures and their access/allowance to a given device are provided. As stated previously, registration for objects such as pets and pet collars or other devices is performed via mobile device and Bluetooth communications for adding and linking the pet/collar with the particular user/owner and particular access point device(s). (e.g. register access point device with collar and on app link the collar and pet).

Accordingly, all such modifications and changes are considered to be within the scope of the appended claims. Accordingly, the specification and the drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

What is claimed is:

1. A system configured to support autonomous receipt of a package carried via a carrier comprising:
a housing;
an access point device operably coupled to said housing, comprising:
a movable panel associated with the housing, the movable panel operative to cover or expose an aperture in the housing;
an actuator disposed in a portion of the housing for automatically causing said movable panel to open or close, thereby exposing or covering the aperture in the housing;
a sensor disposed in a portion of the housing or the movable panel for detecting whether a carrier of a package is within a predetermined region associated with the moveable panel;
a computer controller disposed in a portion of the housing or the movable panel and communicatively coupled with the sensor and the actuator, wherein the controller generates a signal to cause the actuator to open the panel in response to detection by the sensor and verification of the carrier containing the package, to enable receipt of the package into the housing by the carrier;
wherein a communication hub disposed in a portion of the housing or on the panel enables communications from the computer controller as to a status of one or more of the package and the movable panel.

2. The system of claim 1, wherein the carrier comprises an aerial drone, and wherein the movable panel comprises one of a door and a window.

3. The system of claim 2, wherein the actuator comprises a stepper motor, the stepper motor responsive to a directional signal from the computer controller for opening or closing the movable panel.

4. The system of claim 3, where the sensor comprises a passive infrared (PIR) sensor for detecting motion of a carrier of a package within the predetermined region and intended for ingress to said housing via said movable panel.

5. The system of claim 4, further comprising an at least one of a second IR sensor and a video camera, the at least one second IR sensor and the video camera disposed on a frame of the door or the window, and configured for detecting when the package passes through the aperture of the housing, and sending a signal to the controller in response thereto.

6. The system of claim 5, wherein the movable panel comprises a window, and wherein a pair of stepper motors are each contained within a respective motor housing and embedded in opposite sides of a fixed frame of the window.

7. The system of claim 6, wherein each motor housing is also embedded in a portion of the housing.

8. The system of claim 6, wherein each said stepper motor is connected to a draw string attached to a portion of the window for opening and closing the window.

9. The system of claim 8, wherein each said stepper motor is connected to a mesh reel which is deployed in response to a signal from the controller so as to catch the package from the drone.

10. The system of claim 9, wherein the mesh reel is deployed horizontally across a portion of the window frame, and wherein the window panel opens at an acute longitudinal angle relative to the vertical axis to receive and support the package.

11. The system of claim 7, wherein upon detection of said aerial drone and opening of the window, a timer is set to cause the window to close upon expiration of the timer.

12. The system of claim 7, wherein the communications hub further includes a web server to allow remote control and window status.

13. The system of claim 7, wherein upon detection of said aerial drone and opening of the window to receive the package, the controller causes temporary deactivation of the PIR sensor.

14. The system of claim 13, wherein a timing delay is set by the controller to reactivate the PIR sensor.

15. The system of claim 13, further comprising a receiver for receiving an identification code from the carrier, the received identification code being compared with a list of codes stored in memory associated with the controller to determine a match, whereby the controller overrides all other sensor signals and maintains closure of the movable panel until a match is detected.

16. An access point device comprising:
a movable panel disposed in a housing and configured to automatically open and close an aperture (A) in the housing;
an actuator disposed in a portion of the housing for automatically opening or closing the movable panel;
a sensor disposed in a portion of the housing or the movable panel for detecting whether a carrier of a package is within a predetermined region associated with the moveable panel;
a computer controller disposed in a portion of the housing or the movable panel and communicatively coupled with the sensor and the actuator, wherein the controller generates a signal to cause the actuator to open the panel in response to detection by the sensor and verification of the carrier containing the package, to enable receipt of the package into the housing;
wherein a communication hub disposed in a portion of the housing or on the panel enables communications from the computer controller as to a status of one or more of the package and the movable panel.

17. An access point device comprising:
a housing adapted to be disposed in a window opening;
a slidable drawer disposed in the housing;
an actuator disposed in a portion of the housing or slidable drawer for automatically moving the slidable drawer according to control commands received from a computer controller;
a sensor disposed in a portion of the housing or the slidable drawer for detecting whether a carrier of a package is within a predetermined region associated with the moveable panel;
wherein the computer controller is disposed in a portion of the housing or slidable drawer and communicatively coupled with the sensor and the actuator, wherein the controller generates a signal to cause the actuator to move the slidable drawer from a first closed position whereby the slidable drawer and the housing cooperate to block ingress and egress through the window, to a second open position, whereby a portion of the slidable drawer extends outside of the housing in order to receive a package carried via an authorized carrier, in response to sensor detection of an authorized drone.

18. The access point device of claim 17, wherein the computer controller is further adapted to generate a signal to cause the actuator to move the slidable drawer from the second open position back toward the first closed position, in response to a sensor detection of a package in the drawer, or upon expiration of a timer.

19. The access point device of claim 18, wherein the computer controller is further adapted to generate a signal to cause the actuator to move the slidable drawer to a third position, whereby the slidable drawer and the housing cooperate to block ingress and egress through the window at a first end, and whereby a portion of the slidable drawer at a second end opposite the first end, extends outside of the housing into an interior area in order to provide user access to the package, in response to sensor detection of the package in the drawer.

20. The access device of claim 19, wherein a communication hub disposed in a portion of the housing or on the drawer enables communications from the computer controller as to a status of one or more of the package and the slidable drawer.
